(19) United States
(12) Patent Application Publication
(10) Pub. No.: US 2012/0175432 A1
(43) Pub. Date: Jul. 12, 2012

(54) Paint shuttle system

(75) Inventors: Dragoslav Kosta Milojevic, Bloomfield Hills, MI (US); Christopher M. Rennie, Waterford, MI (US); Gary J. Ciarelli, Milford, MI (US); Tianjian Ted Wang, Pontiac, MI (US)

(73) Assignee: ABB INC., Cary, NC (US)

(21) Appl. No.: 13/138,019

(22) PCT Filed: Dec. 22, 2009
(86) PCT No.: PCT/US2009/069088

§ 371 Date: Jan. 27, 2012

Related U.S. Application Data
(60) Provisional application No. 61/140,099, filed on Dec. 23, 2008.

(51) Int. Cl. B05B 12/14

(52) U.S. Cl. 239/329; 239/1

(57) ABSTRACT

A paint delivery system (10) for delivering paint to a spraying device (34). The paint delivery system (10) includes a launch station (42) connected by a flow line (52) to an arrival station (44) and one or more shuttles. Paint and the one or more shuttles are transmitted from the launch station (42) to the arrival station (44) and the paint is delivered from the arrival station (44) to the spraying device (34). After the paint is delivered to the spraying device (34), the one or more shuttles are returned to the launch station (42) through the flow line (52). In one or more embodiments, the paint transmitted from the launch station (42) is followed or preceded by a predetermined amount of solvent disposed between two shuttles.

### BACKGROUND OF THE INVENTION

This invention generally relates to coating systems and more particularly to paint systems using shuttles.

Coating systems for applying coatings to objects, such as vehicles, often utilize supply systems that utilize shuttles, or “pigs”. A shuttle or pig is an object that is sized and shaped to be snugly disposed in a pipe or tube so as to be moveable therein through the application of a pressurized fluid, such as air or a liquid solvent. Often a shuttle is used only to remove or clean a coating from the interior of the tube. Examples of such supply systems are disclosed in U.S. Pat. No. 5,221,047 to Akeel and U.S. Pat. No. 6,037,010 to Kahmann et al.

In the Akeel system, paint from one of a plurality of paint supply valves is supplied to a spray nozzle through a paint line connected between a pair of spaced-apart first and second shuttle stations. The first and second shuttle stations are also connected together by a return line. After paint from one of the paint supply valves is provided to the spray nozzle, a first shuttle followed by an amount of solvent and then a second shuttle are launched from the first shuttle station and moved through the paint line, first by pressurized air and then by paint from a second one of the paint supply valves. After the first and second shuttles arrive at the second shuttle station, they are moved back to the first shuttle station through the return line.

In the Kahmann et al. system, paint from a paint switching device is supplied to a spray nozzle through a paint line having a pair of spaced-apart shuttle stations mounted therein. A shuttle is disposed in the paint line and is movable between the two shuttle stations. A pump in the paint switching device supplies paint to the spray nozzle without the use of the shuttle. While paint is being supplied to the spray nozzle, the shuttle remains parked in one of the shuttle stations and paint flows around the shuttle to the spray nozzle. When paint is no longer being supplied to the spray nozzle, the shuttle is moved through the paint line by pressurized air to remove paint from the paint line.

In other supply systems, a shuttle is used to supply a measured amount of coating to a spray device. An example of such a supply system is disclosed in U.S. Pat. No. 6,582,774 to Klein et al. In the Klein et al. system, a pair of spaced-apart shuttle stations is mounted in a main paint line. A plurality of spray devices (atomizers) are connected by branch lines to the main paint line. A shuttle is disposed in the main paint line and is movable between the two shuttle stations to push a measured amount of paint through the main paint line from a paint supply unit to the spray devices. If the branch lines are long, shuttles and shuttle stations may also be used in the branch lines to move paint from the main paint line to the spray devices.

Although the prior art supply systems described above provide a number of benefits, it would be desirable to provide a supply system that has less paint loss and requires less cleaning solvent. The present invention is directed toward such a supply system.

### SUMMARY OF THE INVENTION

In accordance with the present invention, a paint delivery system is provided having a launch station, an arrival station, a flow line connecting the launch station to the arrival station and a shuttle disposed for movement through the flow line between the launch station and the arrival station. The launch station is operable to transmit paint and the shuttle through the flow line to the arrival station, and the arrival station is operable to transmit the shuttle back through the flow line to the launch station.

Also provided in accordance with the present invention is a method of delivering paint to a spraying device using a shuttle line that includes a shuttle and a launch station connected by a flow line to an arrival station. The method includes disposing the shuttle in the launch station and moving the shuttle out of the launch station, through the flow line and to the arrival station. After the shuttle is moved out of the launch station, paint is injected into the flow line from the launch station. Paint is directed from the arrival station to the spraying device and the shuttle is moved through the flow line back to the launch station.

### BRIEF DESCRIPTION OF THE DRAWINGS

The features, aspects, and advantages of the present invention will become better understood with regard to the following description, appended claims, and accompanying drawings where:

FIG. 1 shows a schematic drawing of a paint system having a shuttle system embodied in accordance with the present invention;

FIG. 2 shows an end perspective view of a body of a launch station in the shuttle system;

FIG. 3 shows a longitudinal sectional view of the launch station with four shuttles disposed therein, wherein the shuttles are ready to be launched;

FIG. 4 shows a cross-sectional view of the launch station;

FIG. 5 shows a longitudinal sectional view of an arrival station in the shuttle system with four shuttles disposed therein, wherein the shuttles have been received from the launch station;

FIG. 6 shows a cross-sectional view of the arrival station;

FIG. 7 shows a side elevational view of a shuttle used in the shuttle system;

FIG. 8 shows a longitudinal sectional view of a second launch station of another embodiment of the present invention;

FIG. 9 shows a cross-sectional view of the second launch station;

FIG. 10 shows a longitudinal sectional view of a second arrival station of another embodiment of the present invention; and

FIG. 11 shows a cross-sectional view of the second arrival station.

### DETAILED DESCRIPTION OF ILLUSTRATIVE EMBODIMENTS

It should be noted that in the detailed description that follows, identical components have the same reference numerals, regardless of whether they are shown in different embodiments of the present invention. It should also be noted that in order to clearly and concisely disclose the present invention, the drawings may not necessarily be to scale and certain features of the invention may be shown in somewhat schematic form.

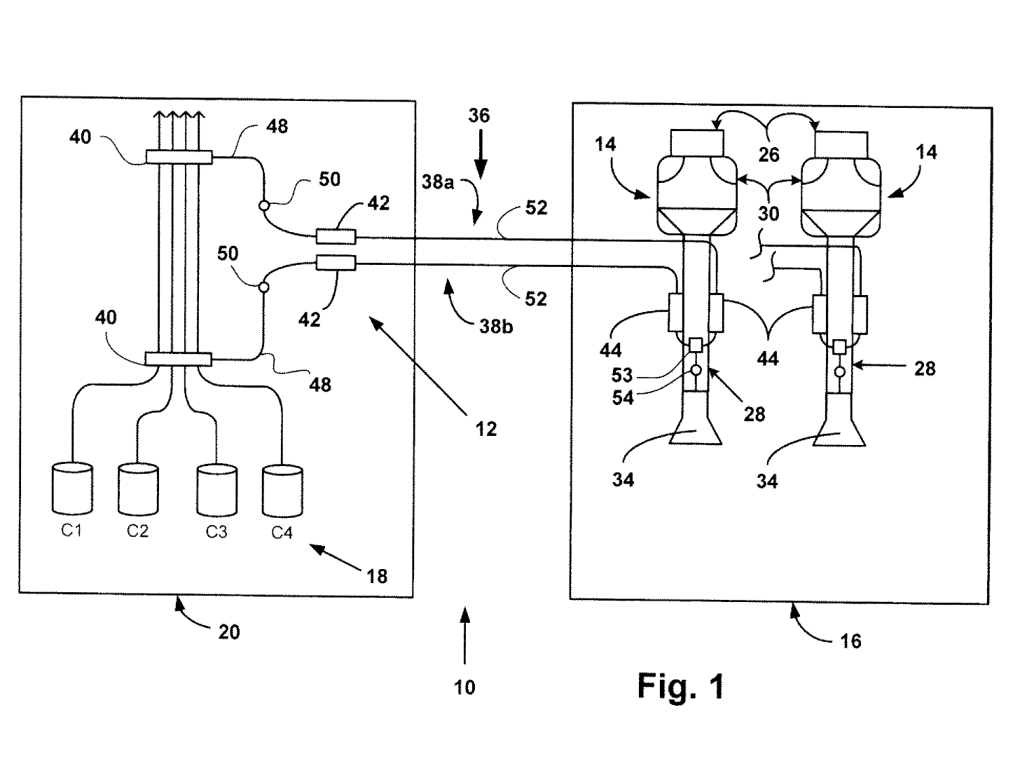

Referring now to FIG. 1 there is shown a paint system 10 having a paint delivery system 12 embodied in accordance with the present invention. In addition to the paint delivery system 12, the paint system 10 generally includes one or more robots 14 located in a spray booth 16 and a plurality of paint holding tanks 18 located in a paint mixing room 20.

Each robot 14 is a multi-axis robot and generally includes a robot controller 26 and an articulated arm 28 mounted to a pedestal or base 30. Each robot controller 26 includes a central processing unit (CPU), memory and storage, such as one or more hard drives. Each robot controller 26 is communicably connected to its associated robot 14. In each robot controller 26, the CPU is operable to execute control software stored in memory to control the operation of the robot 14. The control software is written in a robot user programming language (robot code), such as Karel, KRL or RAPID, all of which are based on the C programming language. In an embodiment of the present invention, the robot code is RAPID, which is used in robotic systems provided by ABB Inc. of Auburn Hills, Mich. The arm 28 of each robot 14 carries a paint delivery device 34. The paint delivery device 34 is connected to a wrist on the arm of each robot 14 and may be a rotary atomizer, which includes an air motor that is operable to rotate an atomizer bell.

The paint delivery system 12 provides paint from the paint holding tanks 18 to the paint delivery devices 34 of the robots 14. The paint delivery system 12 generally includes a plurality of shuttle systems 36, one for each robot 14.

Each shuttle system 36 generally includes a pair of shuttle lines 38a,b, each of which includes a paint selector 40, a launch station 42 and an arrival station 44. For purposes of brevity, only one of the shuttle lines 38 will be described, it being understood that the other shuttle lines 38 are substantially similar. The paint selector 40 is connected by lines to the paint holding tanks 18 and is operable to selectively provide paint from the different holding tanks 18 to the launch station 42. A main paint passage 46 in the launch station 42 is connected by a line 48 to the paint selector 40. A flow meter 50 is connected into the line 48. The launch station 42 is connected to the arrival station 44 by a flow line 52, which is comprised of tubing composed of a metal, such as stainless steel, or solvent-resistant plastic and has an inner diameter that may be between about 10 mm and 20 mm, depending on the required paint consumption rate. The launch station 42 is located close to the paint holding tanks 18, such as in the paint mixing room 20, while the arrival station 44 is located on the robot 14, such as on the arm 28 of the robot 14.

The two arrival stations 44 on the arm 28 of each robot 14 are connected by a selector system to the paint delivery device 34. The selector system includes a selector valve 53 that is operable to selectively provide paint from either the shuttle line 38a or the shuttle line 38b to the paint delivery device 34. The selector system may further include a flow meter 54 for measuring the flow of paint to the paint delivery device 34.

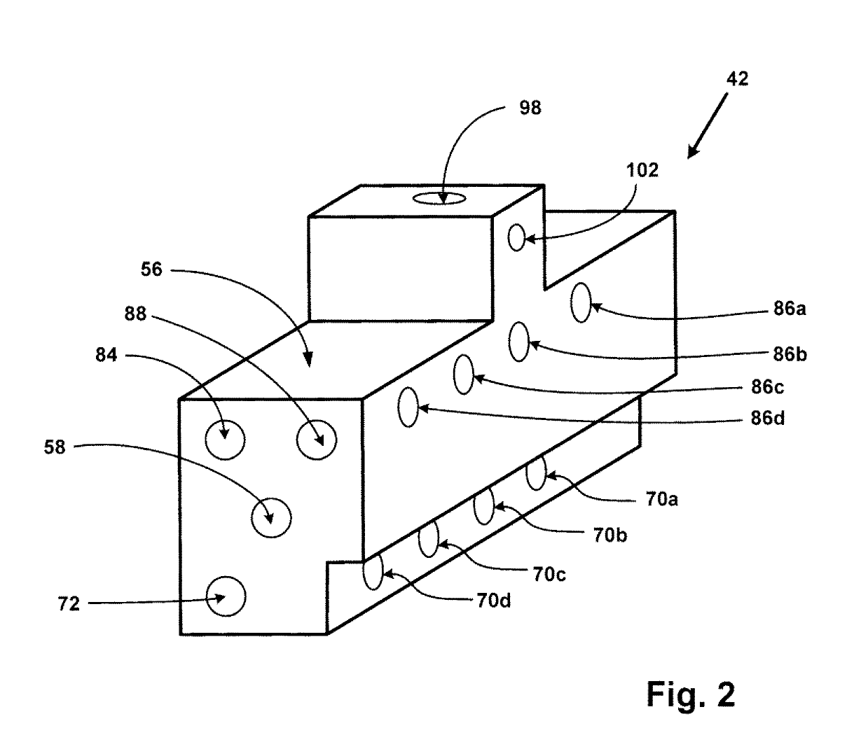

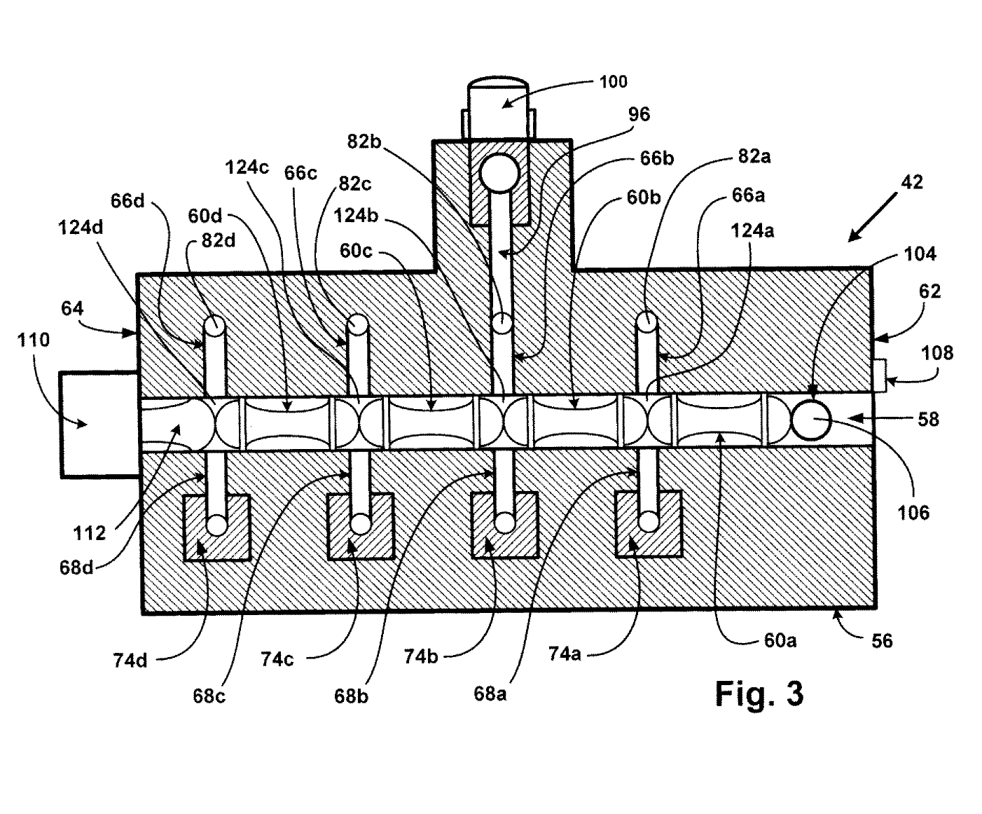

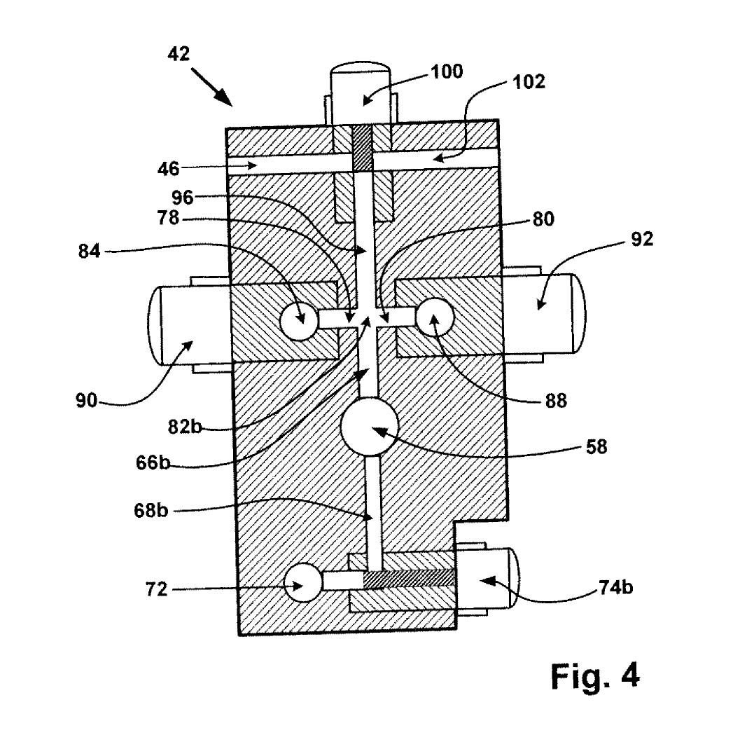

Referring now to FIGS. 2-4, each launch station 42 includes a body 56 composed of a solvent-resistant metal, such as stainless steel. The body 56 defines a plurality of internal passages, including a main passage 58 that is sized to receive a plurality of shuttles 60. In the embodiment shown in FIGS. 2-4, the main passage 58 is sized to accommodate four shuttles 60. The main passage 58 has a front or first opening extending through a front or first end 62 of the body 56 and rear or second opening extending through a rear or second end 64 of the body 56. A plurality of internal supply passages 66 and a plurality of internal dump passages 68 extend normal to, and intersect, the main passage 58. The supply passages 66 are disposed on one side of the main passage 58, i.e., the upper side, while the dump passages 68 are disposed on the other side of the main passage 58, i.e., the lower side. The supply passages 66 are aligned with the dump passages 68, i.e., each supply passage 66 is aligned with a dump passage 68. In this manner, each pair of aligned supply and dump passages 66, 68 intersects the main passage 58 at the same location along the length of the main passage 58. In the embodiment shown in FIG. 3, there are four aligned pairs of supply and dump passages 66, 68, which are further designated by the reference letters a, b, c, d, respectively. All shown devices associated therewith are also further designated by the reference letters a, b, c, d, respectively. In addition, the four shuttles 60 are further designated by the reference letters a, b, c, d. The reference lettering from “a” to “d” corresponds to positions from the front or first end 62 to the rear or second end 64 of the body 56 of the launch station 42.

Each dump passage 68 is connected by a cavity 70 to a main dump passage 72 that extends in the same direction as the main passage 58, but is offset from the main passage 58. A dump valve 74 is disposed in each cavity 70 and is operable to control the flow of fluid from the dump passage 68 to the main dump passage 72. The dump valve 74 may be solenoid actuated. The main dump passage 72 is connected to a recovery tank (not shown) from which paint and/or solvent may be recovered.

An internal solvent passage 78 and an internal air passage 80 are connected to each supply passage 66. The solvent passage 78 and the air passage 80 are aligned and intersect the supply passage 66 at the same location or juncture 82 along the length of the supply passage 66. The solvent passage 78 is connected by a solvent cavity (not shown) to a main solvent passage 84, and the air passage 80 is connected by an air cavity 86 to a main air passage 88. The main solvent passage 84 is connected to a source of solvent (not shown), while the main air passage 88 is connected to a source of compressed air (not shown). A solvent valve 90 is disposed in the solvent cavity and an air valve 92 is disposed in the air cavity 86. The solvent valve 90 is operable to control the flow of solvent from the main solvent passage 84 to the solvent passage 78, while the air valve 92 is operable to control the flow of air from the main air passage 88 to the air passage 80. The solvent valve 90 and the air valve 92 may each be solenoid actuated.

At the junction 82b where the solvent passage 78b and the air passage 80b intersect the supply passage 66b, the supply passage 66b is longitudinally connected to an internal paint passage 96, which, in turn, is connected by a cavity 98 to the main paint passage 46. A paint valve 100 is disposed in the cavity 98 and is operable to control the flow of paint into and out of the paint passage 96. The paint valve 100 may be solenoid-actuated and is a three-way valve. The paint valve 100 has a first operating state, wherein the paint valve 100 connects the main paint passage 46 to the paint passage 96 and a second operating state wherein the paint valve 100 connects the paint passage 96 to an exit passage 102. The paint valve 100 also has a closed state, wherein the paint valve 100 stops all paint flow through the paint valve 100. The main paint passage 46 and the exit passage 102 extend in a direction perpendicular to the paint passage 96 and the supply passage 66.

A first plunger device 104 is mounted to the body 56 toward the first end 62 and includes a movable plunger 106 that is extendible into the main passage 58 through a blocking passage that extends perpendicular to the main passage 58. The plunger 106 is movable between a first position, wherein no portion of the plunger 106 is disposed in the main passage 58, and a second position, wherein a substantial portion of the plunger 106 is disposed in the main passage 58. The plunger 106 moves in a direction perpendicular to the main passage 58 as it travels between the first and second positions. The first plunger device 104 may be solenoid actuated.

A proximity sensor 108 is mounted in, or adjacent to, the main passage 58 and proximate to the first opening of the main passage 58. Depending on the construction of the shuttles 60, the proximity sensor 108 may be an optical or magnetic proximity sensor. For example, if the shuttles 60 are composed of metal or contain a metal insert, the proximity sensor 108 may be magnetic. The proximity sensor 108 may be mounted on the first end 62 of the body 56, above the first opening, as shown in FIG. 3. Alternately, the proximity sensor 108 may be mounted in the plunger 106 of the first plunger device 104.

A second plunger device 110 is mounted to the body 56 at the second end 64 and includes a plunger 112 having a bulbous or curved shape. The plunger 112 is extendible into the main passage 58, through the second opening. More specifically, the plunger 112 is movable between a first position, wherein all or most of the plunger 112 is disposed in the main passage 58, and a second position, wherein no portion (or only a very small portion) of the plunger 112 is disposed in the main passage 58. When the plunger 112 is in the first position, an outer end of the plunger 112 is disposed at about the center of the junction where the supply and dump passages 66d, 68d intersect the main passage 58. The plunger 112 moves in the direction of the main passage 58 as it travels between the first and second positions. The second plunger device 110 may be solenoid actuated.

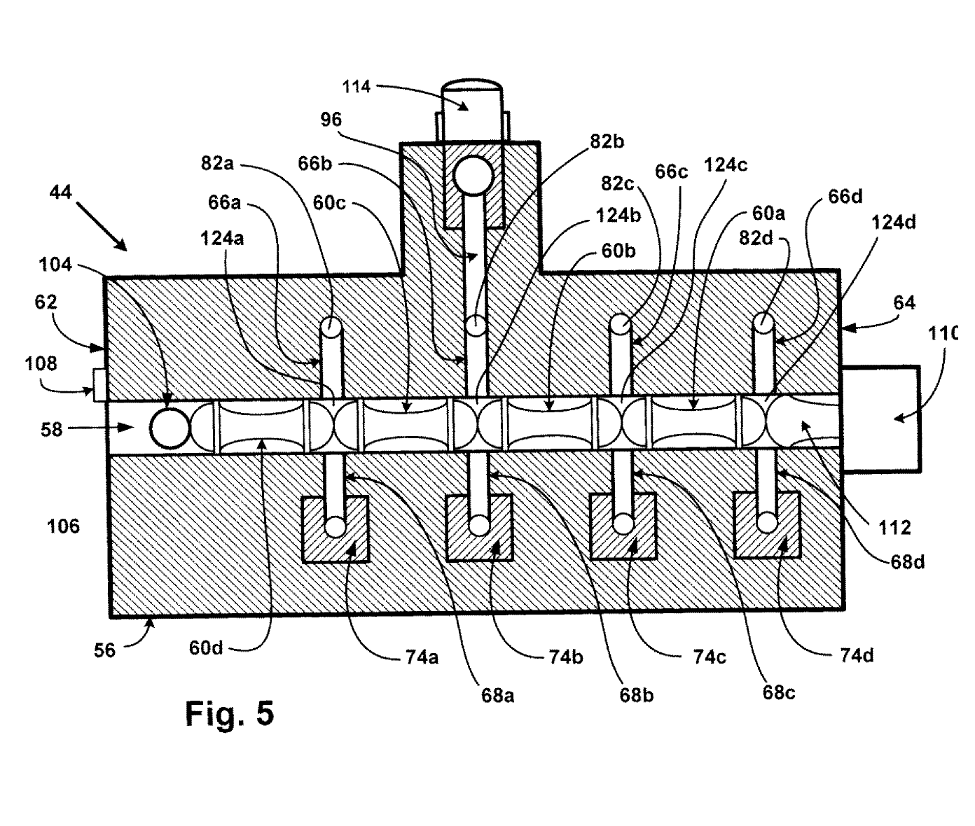

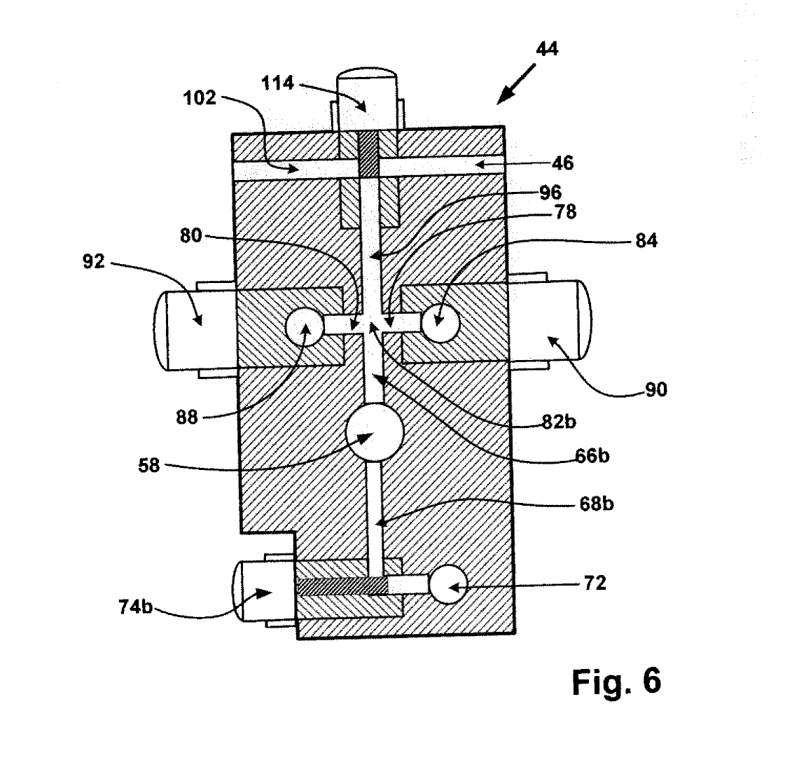

Referring now to FIGS. 5 and 6, the arrival stations 44 have the same construction as the launch stations 42, except for the differences described below. The major difference is that the arrival stations 44 are mirror images of the launch stations 42. Another difference is that in the arrival stations 44, the main paint passage 46 is not present and the paint valve 100 has been replaced by a paint valve 114, which is a two-way valve that controls the flow of paint from the paint passage 96 to the exit passage 102. In addition, the exit passage 102 is connected to the paint delivery device 34 through the selector system, which includes the selector valve 53. Since the arrival stations 44 have substantially the same construction as the launch stations 42, the construction of the arrival stations 44 will not be described in detail. In addition, the same reference numerals will be used for corresponding components of the arrival stations 44 and the launch stations 42.

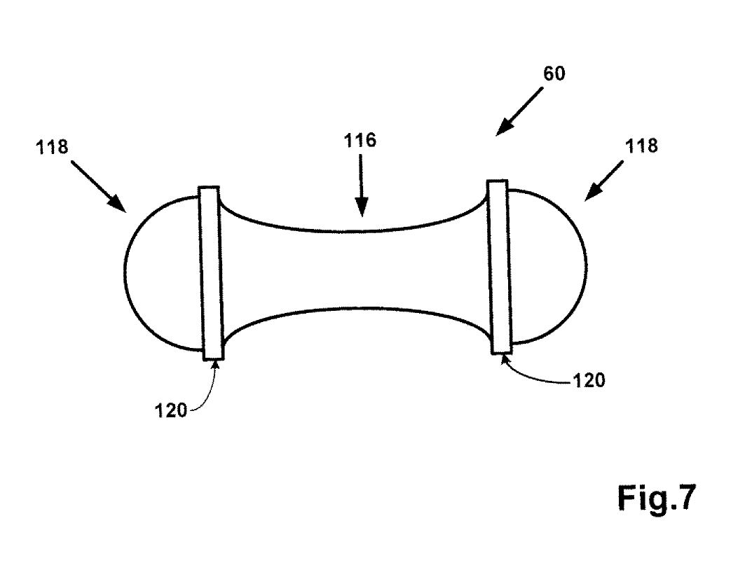

Referring now to FIG. 7, each shuttle 60 has the shape of a waisted or dumbbell-shaped ellipsoid, with a narrow waist 116 joined between opposing bulbous heads 118. Each shuttle 60 may be composed of a solvent resistant plastic material, such as for example, high density polyethylene (HDPE), or polyethylene terephthalate (PETE). A circumferential groove is formed in each of the heads 118 and snugly receives an O-ring 120 composed of a solvent resistant rubber, such as commercially known as Viton, Kalrez or Chemrez. The heads 118 of the shuttles 60 are diametrically sized to permit shuttles 60 to facilely move within the flow line 52, while maintaining seals between the O-rings 120 and an interior surface of the flow line 52. As an alternative, shuttles 60 can be made of a softer plastic material with integral sealing fins in the shape of O-rings 120 machined or molded together with the shuttle heads 118.

In each shuttle system 36, the control elements (e.g., the dump valves 74, the solvent valves 90, the air valves 92) are connected to, and controlled by, the robot controller 26 of the robot 14 with which the shuttle system 36 is associated. In each shuttle system 36, a software routine stored in the memory of the robot controller 26 and executable by the CPU of the robot controller 26 actuates the control elements to perform a paint supply method. In the paragraphs that follow, the paint supply method will be described for one of the shuttle systems 36. The paint supply method is to provide a required amount of paint to the paint delivery device 34 so that the paint delivery device 34 can perform a painting operation, such as painting a component of a car or truck. The required amount of paint is typically known in advance from historical data. Based on this required amount, a predetermined amount of paint is provided from the paint selector 40 to the launch station 42. The predetermined amount of paint is equal to the amount of paint known to be required for the painting operation plus a small additional amount. The required amount and, thus, the predetermined amount of paint may be adjusted by the robot controller 26 during the painting operation based on the usage of paint in the painting operation, as measured by the flow meter 54.

At the beginning of the paint supply method, the selector valve 53 is actuated to select one of the shuttle lines 38a,b to provide paint to the paint delivery device 36. For purposes of description, it will be assumed that shuttle line 38a is selected and the description that follows pertains to shuttle line 38a, except as expressly stated otherwise. The launch station 42 contains all of the shuttles 60. In both the launch station 42 and the arrival station 44, the plunger 106 of the first plunger device 104 is in the first position and the plunger 112 of the second plunger device 110 is in the first position. The shuttles 60a,b,c,d are disposed end-to-end in the main passage 58, as shown in FIG. 2. Since the heads 118 of the shuttles 60 are curved, the abutting heads 118 of each pair of adjacent shuttles 60 cooperate to define gaps 124a,b,c between the heads 118. Similarly, the curved plunger 112 cooperates with the curved head 118 of the shuttle 60d to form a gap 124d. The gaps 124a,b,c,d are aligned with the supply passages 66a,b,c,d, respectively.

In a first step, the dump valve 74d in the arrival station 44 is opened. Next, the solvent valve 90 for the supply passage 66a is opened for a first predetermined amount of time, which allows solvent from the main solvent passage 84 to flow into the supply passage 66a and thence into the gap 124a formed between the shuttle 60a and the shuttle 60b. The ingress of the solvent into the gap 124a pushes the shuttle 60a out of the launch station 42 and into the flow line 52. The solvent and the shuttle 60a move through the flow line 52 to the arrival station 52. After the first predetermined amount of time has elapsed, the solvent valve 90 closes. The first predetermined amount of time during which the solvent valve 90 is open is selected to introduce a predetermined amount of solvent (typically about 100 to 200 milliliters) between the shuttle 60a and the shuttle 60b.

Simultaneously or substantially simultaneously with the closing of the solvent valve 90 for the supply line 66a, the paint valve 100 is moved to the first operating state to direct paint from the main paint passage 46 into the paint passage 96. (The paint valve 100 needs to be moved to the first operating state as soon as possible after the solvent valve 90 for the supply line 60a is closed in order to maintain pressure in the flow line 52.) The paint flows through the paint passage 96 and the supply passage 66b into the gap 124b formed between the shuttle 60b and 60c. The paint pushes the shuttle 60b out of the launch station 42 and into the flow line 52. The paint and the shuttle 60b travel through the flow line 52 to the arrival station 44.

While the paint is flowing into the paint passage 96, the shuttle 60a reaches the arrival station 44. The proximity sensor 108 detects the presence of the shuttle 60a as it enters main passage 58 of the arrival station 44 through the first opening. A counter routine in the method determines that the shuttle 60a is a “first” one of the shuttles 60. In response to the detection of the “first” shuttle 60a, (after a slight predetermined delay) the dump valve 74d in the arrival station 44 closes and the dump valve 74c in the arrival station 44 opens. When the shuttle 60a reaches the plunger 112 of the second plunger device 110 in the arrival station 44, the solvent passes through the dump passage 68c and the open dump valve 74c and exits the arrival station 44 through the main dump passage 72.

When the shuttle 60b reaches the arrival station 44, the proximity sensor 108 detects the presence of the shuttle 60b as it enters main passage 58 of the arrival station 44 through the first opening. The counter routine determines that the shuttle 60b is a “second” one of the shuttles 60. In response to the detection of the “second” shuttle 60b (after a slight predetermined delay), the dump valve 74c closes and the paint valve 114 is ready to be opened to provide paint to the paint delivery device 34 for the painting operation.

After a predetermined amount of paint has flowed from the paint selector 40 (as measured by the flow meter 50) to the launch station 42, the paint valve 100 is moved to the closed state. It should be appreciated that, depending on the painting operation, the flow of the predetermined amount of paint may be achieved before, during or after the arrival of the “second” shuttle 60b at the arrival station 44. Thus, the flow of the predetermined amount of paint may be reached before any paint is actually provided to the paint delivery device 34. As set forth above, the predetermined amount of paint is greater than the amount of paint that is projected to be used by the paint delivery device 34 for the painting operation. Thus, some paint will be left in the arrival station 44 and/or the flow line 52 after the completion of the painting operation by the paint delivery device 34.

When the paint delivery device 34 is actuated, the paint valve 114 of the arrival station 44 is opened. The paint behind the shuttle 60b flows through the supply passage 66b, the paint passage 96, the paint valve 114 and the exit passage 102 and leaves the arrival station 44. The paint then flows through the selector valve 53 to the paint delivery device 34 which performs the painting operation.

Simultaneously or substantially simultaneously with the movement of the paint valve 100 to the closed state, the solvent valve 90 for the supply line 66c is opened for a second predetermined amount of time, which allows solvent from the main solvent passage 84 to flow into the supply passage 66c and thence into the gap 124c formed between the shuttle 60c and the shuttle 60d. (Once again, the solvent valve 90 needs to be opened as soon as possible after the paint valve 100 moves to the closed state in order to maintain pressure in the flow line 52.) The ingress of the solvent into the gap 124c pushes the shuttle 60c out of the launch station 42 and into the flow line 52. The solvent and the shuttle 60c move through the flow line 52 to the arrival station 44. After the second predetermined amount of time has elapsed, the solvent valve 90 closes. The second predetermined amount of time during which the solvent valve 90 is open is selected to introduce a predetermined amount of solvent (typically about 100 to 200 milliliters) between the shuttle 60c and the shuttle 60d.

When the paint delivery device 34 has completed the painting operation, the paint valve 114 of the arrival station 44 is closed and the dump valve 74b is opened. As set forth above, some residual paint will remain in the arrival station 44 and/or the flow line 52. This residual paint is removed by the shuttle 60c, which pushes the residual paint through the passage 68b and the open dump valve 74b of the arrival station 44. The residual paint then exits the arrival station 44 through the main dump passage 72.

Simultaneously or substantially simultaneously with the closing of the solvent valve 90 for the supply line 66c, the air valve 92 for the supply line 66d is opened, which allows compressed air from the main air passage 88 to flow into the supply passage 66d and thence into the gap 124d formed between the shuttle 60d and the plunger 112. The ingress of the solvent into the gap 124d pushes the shuttle 60d out of the launch station 42 and into the flow line 52. The shuttle, 60d under pressure from the compressed air, moves through the flow line 52 to the arrival station 52.

When the shuttle 60c reaches the arrival station 44, the proximity sensor 108 detects the presence of the shuttle 60c as it enters main passage 58 of the arrival station 44 through the first opening. The counter routine determines that the shuttle 60c is a “third” one of the shuttles 60. In response to the detection of the “third” shuttle 60c (after a slight predetermined delay), the dump valve 74b closes and the dump valve 74a opens. When the front of the shuttle 60c reaches the shuttle 60b inside the main passage 58 of the arrival station 44, the solvent passes through the dump passage 68a and the open dump valve 74a and exits the arrival station 44 through the main dump passage 72.

When the shuttle 60d reaches the arrival station 44, the proximity sensor 108 detects the presence of the shuttle 60d as it enters the main passage 58 of the arrival station 44 through the first opening. The counter routine determines that the shuttle 60d is a “fourth” one of the shuttles 60. In response to the detection of the “fourth” shuttle 60d (after a slight predetermined delay), a cleaning sequence for the shuttle line 38a is initiated and the selector valve 53 is actuated to select the shuttle line 38b to provide the next supply of paint to the paint delivery device 36. The next supply of paint through the shuttle line 38b may be performed during the performance of the cleaning sequence on the shuttle line 38a. The next supply of paint through the shuttle line 38b is performed in the same manner as described above for the shuttle line 38a.

It should be appreciated that in the portion of the paint supply method described above, a predetermined amount (or slug) of solvent, followed by a predetermined amount of paint, and then another predetermined amount (or slug) of solvent are transported from the launch station 42 to the arrival station 44. The slugs of solvent bracketing the paint clean the flow line 52 using a reduced amount of solvent.

In accordance with the cleaning sequence, the first plunger device 104 of the arrival station 44 is first actuated to move the plunger 106 to the second position, which prevents any of the shuttles 60 from escaping the arrival station 44 during the cleaning sequence. Next, the dump valves 74b,c,d are opened (the dump valve 74a already being open) and all of the solvent valves 90 and all of the air valves 92 are opened. A turbulent mixture of solvent and air flows through the supply passages 66a,b,c,d and into contact with the shuttles 60a,b,c,d, thereby cleaning them. The mixture of solvent and air exits the arrival station 44 through the open dump valves 74a,b,c,d.

At least a portion of the cleaning sequence may be directed toward cleaning the waists 116 of the shuttles 60. In order to do so, the second plunger device 110 of the arrival station 44 is actuated to move the plunger 112 to the second position. The location of the plunger 112 in the second position permits the shuttles 60 to move toward the second end 64 of the body 56 of the arrival station 44. This movement causes the waists 116 to move into alignment with the supply passages 66, thereby permitting the solvent/air mixture to contact and clean the waists 116.

The solvent/air mixture is sprayed on the shuttles 60 for a predetermined period of time. After this predetermined period of time elapses, the solvent valves 90 and the air valves 92 are first closed, then the dump valves 74a,b,c,d are closed and then the first and second plunger devices 104, 110 are actuated to move the plungers 106, 112 back to their first positions. When these actions are completed, the shuttles 60a,b,c,d are sent back from the arrival station 44 and received by the launch station 42 in substantially the same manner as they were originally sent from the launch station 42 and received by the arrival station 44, except the shuttles 60a,b,c,d are sent and received in reverse order, i.e., the shuttle 60d is sent and received first. In addition, a predetermined amount of solvent (and not paint) is disposed between the second and third shuttles 60 to leave the arrival station 44, namely shuttle 60c and shuttle 60b. In connection therewith, the solvent valve 90 for the supply line 66b in the arrival station 44 is opened for a predetermined amount of time to inject the predetermined amount of solvent between the shuttle 60c and 60b. In this manner, three slugs of solvent (and no paint) are transported between the shuttles 60 on their trip back to the launch station 42.

When the shuttles 60a,b,c,d are all received back in the launch station 42, another cleaning sequence may be performed in the launch station 42 that is substantially the same as the cleaning sequence performed in the arrival station 44 described above. A cleaning sequence is also performed on the paint selector 40. At this point, the shuttle line 38a is ready to supply a different color paint from another one of the paint holding tanks 18.

It should be appreciated that various modifications may be made to the shuttle system 36 and the control thereof. For example, in a second embodiment of the present invention, each of the shuttle lines 38a,b is constructed and operated to use only three shuttles 60, instead of the four shuttles 60 described above. In the second embodiment, the launch station 42 and the arrival station 44 in each of the shuttle lines 38a,b are shorter and can accommodate only three shuttles. More specifically, only shuttles 60b,c,d are accommodated. In the launch station 42, the supply passage 66a, the dump passage 68a and all of the control elements associated therewith (e.g. the dump valve 74a) are not present, and the main passage 58 is shortened in front of the supply passage 66b such that the shuttle 60b is disposed proximate to the plunger 106 of the first plunger device 104. In the arrival station 44, the supply passage 66d, the dump passage 68d and all of the control elements associated therewith (e.g. the dump valve 74d) are not present, and the main passage 58 is shortened rearward of the supply passage 66c such that the supply passage 66c and the dump 68c are located where the supply passage 66d and the dump passage 68d were formerly located. The operation of the second embodiment is substantially the same as in the first embodiment described above, except that the launch station 42 does not inject a first slug of solvent into the flow line 52 in front of the predetermined amount of paint. The shuttle 60b is now the first of the shuttles 60 to be launched. As in the first embodiment, the shuttle 60b is launched when paint is introduced into the gap 124b. Thus, in the second embodiment, only the predetermined amount of paint (with the leading shuttle 60b) and a following slug of solvent are introduced into the flow line 52 by the launch station 42. In addition, the arrival station 44 only injects two slugs of solvent into the flow line 52 on the return trip, instead of the three slugs injected in the first embodiment.

In a third embodiment of the present invention, each of the shuttle lines 38a,b is constructed and operated to use only two shuttles 60, instead of the three or four shuttles 60 described above. In the third embodiment, the launch station 42 and the arrival station 44 in each of the shuttle lines 38a,b are even shorter and can accommodate only two shuttles. More specifically, only shuttles 60c,d are accommodated. In the launch station 42, the supply passage 66a, the dump passage 68a and all of the control elements associated therewith (e.g. the dump valve 74a) are not present, and the main passage 58 is shortened in front of the supply passage 66b such that the shuttle 60c is disposed proximate to the plunger 106 of the first plunger device 104. In the arrival station 44, the supply passages 66c 66d, the dump passages 68c, 68d and all of the control elements associated therewith (e.g. the dump valves 74c, 74d) are not present, and the main passage 58 is shortened rearward of the supply passage 66b such that the supply passage 66b and the dump 68b are located where the supply passage 66d and the dump passage 68d were formerly located. The operation of the third embodiment is substantially the same as in the first embodiment described above, except that the launch station 42 does not inject a first slug of solvent (or for that matter, any shuttles 60) into the flow line 52 in front of the predetermined amount of paint. The paint is the first item to be injected into the flow line 52. After the predetermined amount of paint has been injected, the shuttle 60c is launched by introducing solvent into the gap 124c. Thus, in the third embodiment, only the predetermined amount of paint (without the leading shuttle 60b) and a following slug of solvent are introduced into the flow line 52 by the launch station 42. In addition, the arrival station 44 only injects a single slug of solvent into the flow line 52 on the return trip, instead of the three slugs injected in the first embodiment.

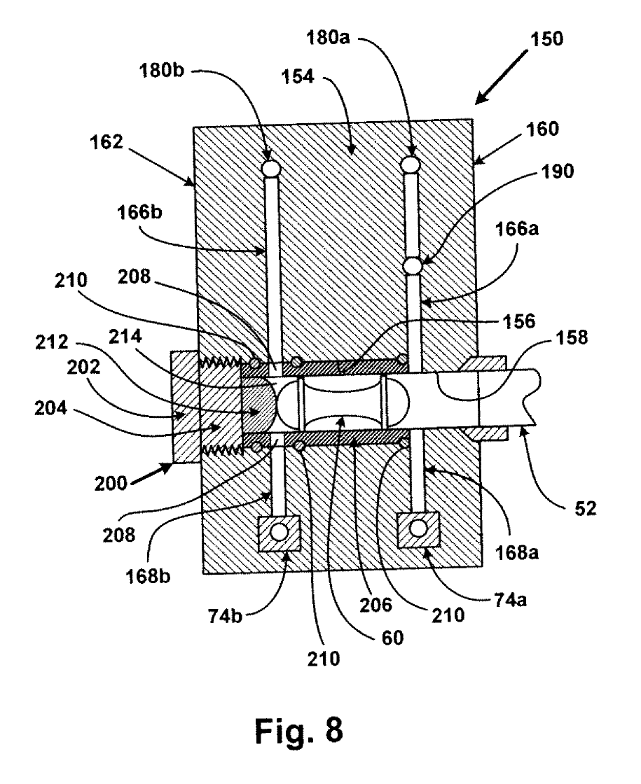

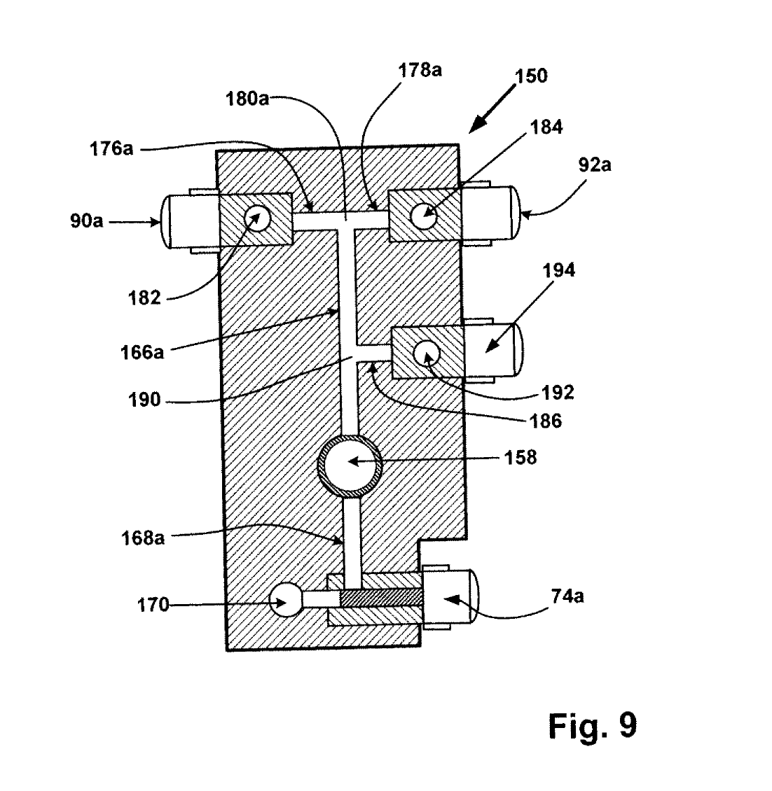

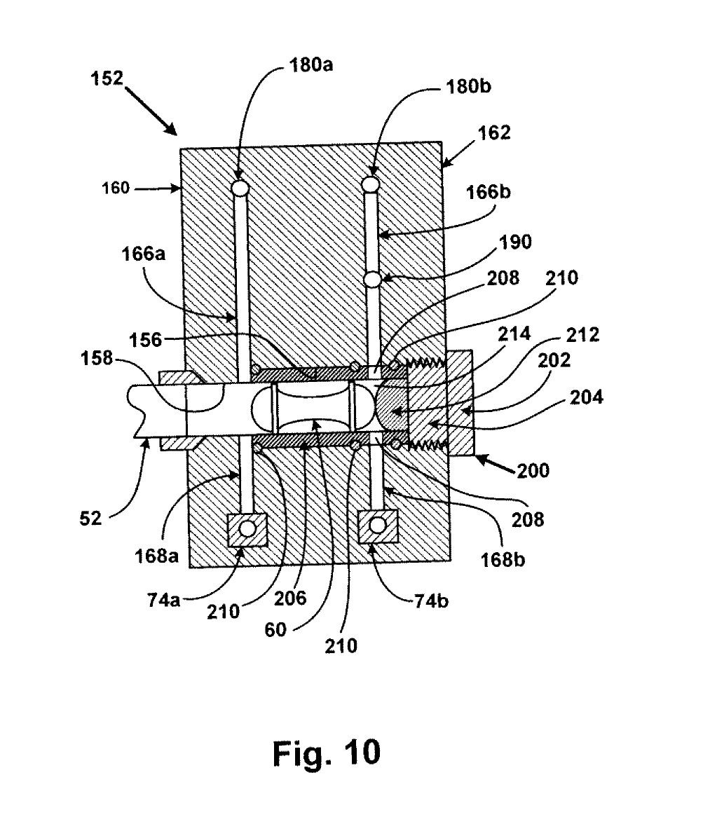

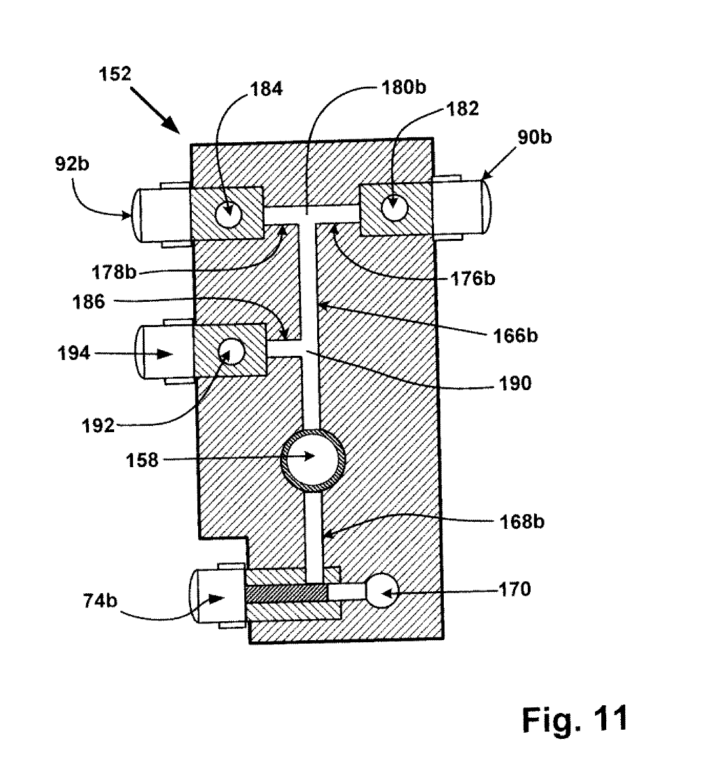

In a fourth embodiment of the present invention, each of the shuttle lines 38a,b utilizes a launch station 150 shown in FIGS. 8 and 9 and an arrival station 152 shown in FIGS. 10 and 11. The launch stations 150 and the arrival stations 152 are constructed and operated to use only one shuttle 60.

Each launch station 150 includes a body 154 composed of a solvent-resistant metal, such as stainless steel. The body 154 defines a plurality of internal passages, including a main bore 156 adjoining a main passage 158. The main passage 158 has a front opening extending through a front end 160 of the body 154, while the main bore 156 has a rear opening extending through a rear end 162 of the body 154. An interior surface of the body 154 defining the main bore 156 is threaded toward the rear opening in the rear end 162. An internal supply passage 166a and an internal dump passage 168a extend normal to, and intersect, the main passage 158, while an internal supply passage 166b and an internal dump passage 168b extend normal to, and intersect, the main bore 156. The supply passages 166a,b are aligned with the dump passages 168a,b, respectively. The dump passages 168a,b are connected to a main dump passage 170 through solenoid-actuated dump valves 74a,b, respectively.

An internal solvent passage 176a and an internal air passage 178a are connected to the supply passage 166a at a juncture 180a, and an internal solvent passage 176b and an internal air passage 178b are connected to the supply passage 166b at a juncture 180b. The solvent passages 176a,b are connected to a main solvent passage 182 through solenoid-actuated solvent valves 90a,b, respectively. The air passages 178a,b are connected to a main air passage 184 through solenoid-actuated air valves 92a,b, respectively. The main solvent passage 182 is connected to a source of solvent (not shown), while the main air passage 184 is connected to a source of compressed air (not shown).

An internal paint passage 186 is connected to the supply passage 166a at a juncture 190, which is located between the juncture 180a and the main passage 158. The paint passage 186, in turn, is connected to an internal main paint passage 192 through a solenoid-actuated paint valve 194. The main paint passage 192 is connected by the line 48 to the paint selector 40. The paint valve 194 is operable to control the flow of paint from the main paint passage 192 to the paint passage 186.

A shuttle cartridge 200 is removably mounted to the body 154 of the launch station 150 and extends into the main bore 156. The shuttle cartridge 200 includes a head 202 joined to a mount 204, which, in turn, is joined to a hollow cylindrical trunk 206. The head 202 has a circumferential surface adapted for gripping by a tool such as a wrench. For example the head 202 may have a hexagonal circumferential surface. The mount 204 has a circumferential surface with a thread adapted to threadably mate with the thread in the interior surface of the body 154 defining the main bore 156. With the above-described construction, the shuttle cartridge 190 can be threadably secured to the body 154 using a tool, such as a wrench. The head 202, mount 204 and trunk 206 are composed of a corrosion-resistant metal, such as stainless steel.

The trunk 206 has an open end that adjoins the main passage 158 when the shuttle cartridge 200 is mounted to the body 154 of the launch station 150. Opposing openings 208 are formed in a side wall of the trunk 206 and are respectively aligned with the supply passage 166b and the dump passage 168b when the shuttle cartridge 200 is mounted to the body 154. A plurality of circumferential grooves are formed in the trunk 206. A pair of the grooves bracket the openings 198 and another groove is located at the open end. O-rings 210 are disposed in the grooves and form seals with the interior surface of the main bore 156 around the openings 208 and at the open end when the shuttle cartridge 200 is mounted to the body 154. The O-rings 210 may be composed of a solvent-resistant rubber, such as that which is commercially known as Viton, Kalrez or Chemrez. An arcuate protuberance 212 is secured to an inner end of the mount 204 and extends into the trunk 206. The trunk 206 is sized to hold a single shuttle 60. When the shuttle 60 is disposed in the trunk 206, the curved protuberance 212 cooperates with the curved head 118 of the shuttle 60 to form a gap 214.

Referring now to FIGS. 10 and 11, the arrival station 152 has the same construction as the launch station 150, except for the differences described below. The major difference is that the arrival station 152 is a mirror image of the launch station 150. In addition, the internal paint passage 186 is connected to the supply passage 166b instead of the supply passage 166a. Another difference is that in the arrival station 152, the main paint passage 192 is connected to the paint delivery device 34 (through the selector system) instead of the paint selector 40. In connection therewith, the paint valve 194 is operable to control the flow of paint from the paint passage 186 to the main paint passage 192. Since the arrival station 152 has substantially the same construction as the launch station 150, the construction of the arrival station 152 will not be described in detail. In addition, the same reference numerals will be used for corresponding components of the arrival stations 152 and the launch station 150.

The paint supply method run by the robot controller 26 to control the shuttle system 36 with the launch stations 150 and the arrival stations 152 once again begins with the selector valve 53 being actuated to select one of the shuttle lines 38a,b (e.g. the shuttle line 38a) to provide paint to the paint delivery device 36. The dump valve 74b in the arrival station 152 is opened first. Then the paint valve 194 in the launch station 150 is opened to allow paint from the main paint passage 192 to flow into the paint passage 186 and thence the supply passage 166a, the main passage 158 and the flow line 52. After a predetermined period of time, the flow line 52 is considered to be filled with paint and the dump valve 74d in the arrival station 152 is closed. When a predetermined amount of paint has been injected, the paint valve 194 in the launch station 150 is closed and the shuttle 60 is launched from the launch station 150 by opening the air valve 92b (and, optionally, briefly the solvent valve 90b) to introduce compressed air (and optionally a small amount of solvent) into the gap 214. When the paint delivery device 34 is actuated, the paint valve 194 in the arrival station 152 is opened to provide paint to the paint delivery device 34. After the delivery of paint to the paint delivery device 34 is completed, the paint valve 194 in the arrival station 152 is closed, the paint dump valve 74b in the arrival station 152 is opened and the residual paint is pushed into the main dump passage 170 by the arrival of the shuttle 60 at the protuberance 212. The shuttle 60 is then cleaned in a cleaning sequence that begins with the opening of the dump valve 74b in the launch station 150. In the arrival station 152, the dump valve 74a is opened and then the solvent valve 90a and the air valve 92a are opened and then, after a period of time, closed. Afterwards, the solvent valve 90b and the air valve 92b in the arrival station 152 are opened and then, after a period of time, closed, which pushes the shuttle 66 back to the launch station 150. Once the shuttle 60 is back at the launch station 150, the same procedure is followed, which causes the shuttle 60 to be pushed to the arrival station 152. This back and forth process is performed a predetermined number of times and then the shuttle 66 is returned to the launch station 150 and the dump valves 74a,b in the launch and arrival stations 150, 152 are closed.

The construction of the launch station 150 and the arrival station 152 to have the removable shuttle cartridge 200 provides for easy removal and replacement of a shuttle, such as the shuttle 60. Accordingly, a disposable shuttle may be used in the shuttle system 36 of the fourth embodiment, wherein the shuttle is replaced after every painting operation, or every second, third, etc. painting operation.

It is to be understood that the description of the foregoing exemplary embodiment(s) is (are) intended to be only illustrative, rather than exhaustive, of the present invention. Those of ordinary skill will be able to make certain additions, deletions, and/or modifications to the embodiment(s) of the disclosed subject matter without departing from the spirit of the invention or its scope, as defined by the appended claims.

What is claimed is:

1. A paint delivery system comprising:
a launch station;
an arrival station;
a flow line connecting the launch station to the arrival station;
a shuttle disposed for movement through the flow line between the launch station and the arrival station;
wherein the launch station is operable to transmit paint and the shuttle through the flow line to the arrival station; and
wherein the arrival station is operable to transmit the shuttle back through the flow line to the launch station.

2. The paint delivery system of claim 1, wherein the shuttle is a first shuttle and further comprising a second shuttle disposed for movement through the flow line between the launch station and the arrival station

3. The paint delivery system of claim 2, wherein the launch station is operable to transmit the paint followed by an amount of solvent disposed between the first and second shuttles.

4. The paint delivery system of claim 2, wherein the launch station is operable to transmit the paint preceded by an amount of solvent disposed between the first and second shuttles.

5. The paint delivery system of claim 1, wherein the shuttle is a first shuttle and further comprising second, third and fourth shuttles disposed for movement through the flow line between the launch station and the arrival station, and wherein the launch station is operable to transmit the first, second, third and fourth shuttles through the flow line to the arrival station, with a first amount of solvent disposed between the first shuttle and the second shuttle, the paint disposed between the second shuttle and the third shuttle and a second amount of solvent disposed between the third shuttle and the fourth shuttle.

6. The paint delivery system of claim 1, wherein the launch station, the arrival station, the shuttle and the flow line help form a first shuttle line, and wherein the paint delivery system further comprises a second shuttle line comprising:
a second launch station;
a second arrival station;
a second flow line connecting the second launch station to the second arrival station;
a second shuttle disposed for movement through the second flow line between the second launch station and the second arrival station;
wherein the second launch station is operable to transmit paint and the second shuttle through the second flow line to the second arrival station; and
wherein the second arrival station is operable to transmit the second shuttle back through the second flow line to the second launch station.

7. The paint delivery system of claim 6, further comprising a selection system connected to the first and second shuttle lines, the selection system being operable to provide paint from a selected one of the first and second shuttle lines to the spraying device.

8. The paint delivery system of claim 1, wherein the launch station comprises:
a body having a main launch passage and a fluid delivery system operable to selectively inject the paint and one or more fluids into the main launch passage; and
a controller operable to control the fluid delivery system to perform a paint delivery method comprising:
with the shuttle in the main launch passage of the launch station, injecting the paint into the flow line through the main launch passage; and
after injecting the paint into the flow line, injecting a fluid into the main launch passage to move the shuttle through the flow line to the arrival station.

9. The paint delivery system of claim 8, wherein the fluid comprises compressed air, and wherein the launch station further comprises a cartridge extending into and closing an end of the main launch passage, the cartridge being removably mounted to the body to provide access to the main launch passage and the shuttle.

10. The paint delivery system of claim 8, wherein the arrival station is mounted to an arm of a multi-axis robot and the controller is a robot controller, which is also operable to control the movement of the robot.

11. A method of delivering paint to a spraying device using a shuttle line comprising a shuttle and a launch station connected by a flow line to an arrival station, the method comprising:
disposing the shuttle in the launch station;
moving the shuttle out of the launch station, through the flow line and to the arrival station;
after the shuttle is moved out of the launch station, injecting the paint into the flow line from the launch station;
directing the paint from the arrival station to the spraying device; and
moving the shuttle through the flow line back to the launch station.

12. The method of claim 11, wherein the launch station has a main passage connected to the flow line, and wherein the step of moving the shuttle out of the launch station comprises injecting a predetermined amount of solvent into the main passage behind the shuttle.

13. The method of claim 12, wherein the shuttle is a first shuttle and wherein the shuttle line further comprises a second shuttle, and wherein the method further comprises:
disposing the second shuttle in the launch station; and
moving the second shuttle out of the launch station, through the flow line and to the arrival station ahead of the paint.

14. The method of claim 13, wherein the step of moving the second shuttle out of the launch station comprises injecting the paint.

15. The method of claim 13, wherein the shuttle line further comprises a third shuttle, and wherein the method further comprises:
disposing the third shuttle in the launch station; and
moving the third shuttle out of the launch station, through the flow line and to the arrival station behind the second shuttle.

16. The method of claim 15, wherein the step of moving the third shuttle out of the launch station comprises injecting a second predetermined amount of solvent into the main passage behind the third shuttle.

17. The method of claim 16, wherein the shuttle line further comprises a fourth shuttle, and wherein the method further comprises:
disposing the fourth shuttle in the launch station; and
moving the fourth shuttle out of the launch station, through the flow line and to the arrival station behind the third shuttle.

18. The method of claim 17, wherein the step of moving the fourth shuttle out of the launch station comprises injecting pressurized air into the main passage behind the fourth shuttle.
